(19) United States
(12) Patent Application Publication
(10) Pub. No.: US 2007/0031027 A1
(43) Pub. Date: Feb. 8, 2007

(54) Method and system for vertically aligning tile images of an area of interest of an integrated circuit

(75) Inventors: Neal Stansby, Richmond (CA); Lev Klibanov, Ottawa (CA)

Correspondence Address: OGILVY RENAULT LLP, 1981 MCGILL COLLEGE AVENUE, SUITE 1600, MONTREAL, QC, H3A2Y3, CA

(73) Assignee: CHIPWORKS INC., Ottawa (CA)

(21) Appl. No.: 11/196,755

(22) Filed: Aug. 4, 2005

(51) Int. Cl. G06K 9/00

(52) U.S. Cl. 382/151

(57) ABSTRACT

A system and method for aligning tile images of an area of interest of an integrated circuit having N metal layers M, where N>1, includes a parametric representation algorithm for extracting parametric representations of edges from an image showing metal layer (M_{N}) and at least a proportion of metal layer (M_{N-1}) of the integrated circuit to produce a parametric representation of the edges visible on the respective metal layers. The parametric representations include an indication of the metal layer with which each extracted edge is associated and at least one of x and y coordinates associated with each of the extracted edges.

### CROSS-REFERENCE TO RELATED APPLICATIONS

This is the first application filed for the present invention.

### MICROFICHE APPENDIX

Not Applicable.

### TECHNICAL FIELD

The present invention relates in general to integrated circuit analysis and in particular to a Method and system for vertically aligning tile images of an area of interest of an integrated circuit.

### BACKGROUND OF THE INVENTION

There has been a long standing need for determining the structure and configuration of integrated circuits for various reason including quality control and competition intelligence.

FIG. 1 is a schematic diagram of a typical system use a for analyzing integrated circuit in accordance with the prior art. The system includes die surface preparation equipment 10 for preparing the surface of a die to permit imaging of the surface in a manner known in the art. The die surface preparation equipment 10 may use any one of a variety of known materials and/or machines for preparing a die surface using mechanical abrasion, chemical etching, polishing, etc. One method used for delayering integrated circuits is anisotropic removal of dielectric layers using a dry anisotropic etching machine. In general, when anisotropic etching is performed some or all dielectric layers are removed down to the interconnect layer of interest. Metal conductors of the exposed interconnect layers are left sitting on pedestal of dielectric material.

Sequential layer removal is performed, as noted above, using mechanical polishers, dry etching, or chemical solutions well known in art. Once the die surface is prepared, a die 11 is positioned on a precision stage 14 for image capture using an image capturing system 12, which may be an optical or scanning electron microscope. The precision stage may be controlled by a mechanical positioning system or more precisely by a laser control system 16. In either case, captured images are stored on an image data storage 18 which may be connected via a local area network or a wide area network (LAN/WAN) 20 to a computing machine 22 that executed stitching software to create mosaic images of respective layers of the prepared die 11. The mosaic images 24 are downloaded to a design analysis workstation 26 by an engineer analyst who inspects the mosaic images to extract a layout and structure of the area of interest of the integrated circuit.

As is well known in the art, the stitching software 22 includes many algorithms for ensuring precise alignment between mosaic images of different layers of the integrated circuit. Depending on the precision of the stage 14, the alignment of the mosaic images may be more or less accurate. It is well understood in the art that the more accurate the alignment between mosaic images, the better the analysis of the integrated circuit. Consequently, the methods and algorithms have been developed for aligning mosaic images using features common to two or more of the images. For example, vias which are wire connections between layers are commonly used to align images. A drawback of this method is that the vias may be occluded in certain layers. A further drawback is that the vias may be widely separated making accurate inter-layer alignment difficult.

There therefore exists a need for a system and apparatus that permits highly accurate alignment of mosaic images of an area of interest of an integrated circuit.

### SUMMARY OF THE INVENTION

It is therefore an object of the invention to provide a system and method for aligning mosaic images of an integrated circuit in a way that permits a high degree of accuracy.

In accordance with the first aspect of the invention there is provided a system for aligning tile images of an area of interest of an integrated circuit having N metal layers M, where N>1, comprising a parametric representation algorithm for extracting parametric representations of edges from a tile image showing metal layer (M_{N}) and at least a part of metal layer (M_{N-1}) of the integrated circuit to produce a parametric representation of the edges visible on the respective metal layers, the parametric representation including an indication of the metal layer with which each extracted edge is associated and at least one of x and y coordinates associated with each of the extracted edges.

In accordance with a further aspect of the invention there is provided a method of aligning tile images of an area of interest of an integrated circuit having N metal layers M, where N is an integer and N>1, comprising: preparing a surface of the integrated circuit to permit an area of interest of the metal layer (M_{N}) and at least a part of a top surface of the metal layer (M_{N-1}) to be imaged; capturing at least one tile image of the area of interest of the metal layer (M_{N}) and the metal layer (M_{N-1}) of the integrated circuit; extracting edges of a secondary tile image of the metal layer (M_{N-1}) and a primary tile image of the same area of metal layer (M_{N-1}); and creating a parametric representation of edges visible in the tile images of the respective metal layers, the parametric representations including an indication of the metal layer with which each extracted edge is associated.

### BRIEF DESCRIPTION OF THE DRAWINGS

Further features and advantages of the present invention will become apparent from the following detailed description, taken in combination with the appended drawings, in which:

FIG. 1 is a schematic diagram of an integrated circuit analysis system in accordance with the prior art;

FIG. 2 is a flow chart of processes for image acquisition in accordance with the invention, by which tile images of an area of interest of an integrated circuit die are acquired;

FIG. 3 is a schematic diagram of tile images of a metal layer N acquired in accordance with the process shown in steps 32-42 of FIG. 2;

FIG. 4 is a schematic diagram of tile images of metal layers N and N−1 acquired in accordance with the process shown in steps 32-42 of FIG. 2;

FIG. 5 is a schematic diagram of tile images of the metal layer N−1 acquired in accordance with the process shown in steps 32-42 of step 2;

FIG. 6 is a schematic diagram of tile images of metal layer N and N−1 acquired in accordance with process shown in steps 44-54 of FIG. 2;

FIG. 7 is a schematic diagram of tile images of the metal layer N−1 acquired in accordance with the process shown in steps 44-54 of FIG. 2;

FIGS. 8a and 8b are a flow chart of an algorithm in accordance with the invention for computing parametric representations of the tile images shown in FIGS. 3-7;

FIG. 9 is a schematic diagram of an exemplary process for updating a parametric representation of a tile image in which there are no common edges in a primary and secondary tile image of the area of interest of the integrated circuit die;

FIG. 10 is a flow chart of a process in accordance with the invention for displaying tile images representing a slice of an area of interest of an integrated circuit die; and

FIG. 11 is a flow chart of a process in accordance with the invention for computing a three-dimensional model of an area of interest of an integrated circuit die.

It will be noted that throughout the appended drawings, like features are identified by like reference numerals.

### DETAILED DESCRIPTION OF THE PREFERRED EMBODIMENT

The present invention provides a system and method for aligning tile image of an area of interest of an integrated circuit having a plurality of metal layers. In accordance with the invention, there is provided a parametric representation algorithm for extracting parametric representations of edges from a tile image showing a first metal layer and at least a portion of a second metal layer underlying the first metal layer. Each parametric representation includes an indication of the metal layer with which an extracted edge is associated and at least one of the an X and a Y coordinate associated with each of the extracted edges.

The method in accordance with the invention permits alignment of tile images associated with an area of interest of an integrated circuit having N metal layers M, where N is an integer and N is greater than 1. The method includes a first step of preparing a surface of the integrated circuit to permit an area of interest of the metal layer (M_{N}) and at least a part of a top surface of the metal layer (M_{N-1}) to imaged. The method further comprises capturing at least one tile image of the area of interest of the metal layer (M_{N}) and the exposed part of the metal layer (M_{N-1}) of the integrated circuit. Edges of a secondary tile image of the exposed part of metal layer (M_{N-1}) are then extracted, as are edges of a primary tile image of the same area of metal layer (M_{N-1}). A parametric representation of edges visible in the tile images of the respective metal layers is then created. The parametric representations include an indication of the metal layer with which each extracted edge is associated. The parametric representations are used to vertically align tile images, most conveniently when the tile images are displayed on a design analysis workstation. A very high degree of alignment accuracy can be achieved using the method and systems in accordance with the invention. The alignment accuracy permits a more accurate and reliable analysis of the area of interest of the integrated circuit.

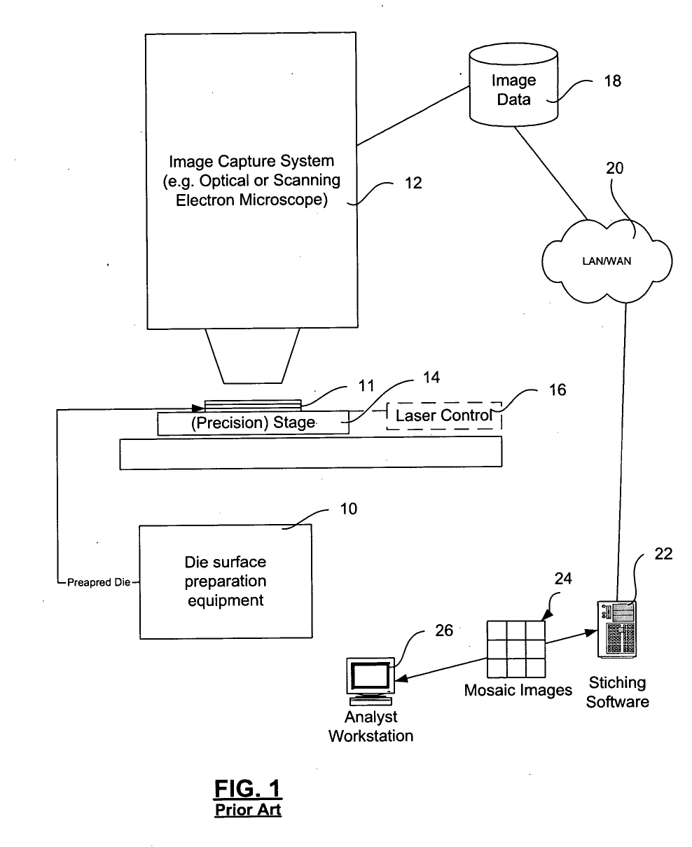

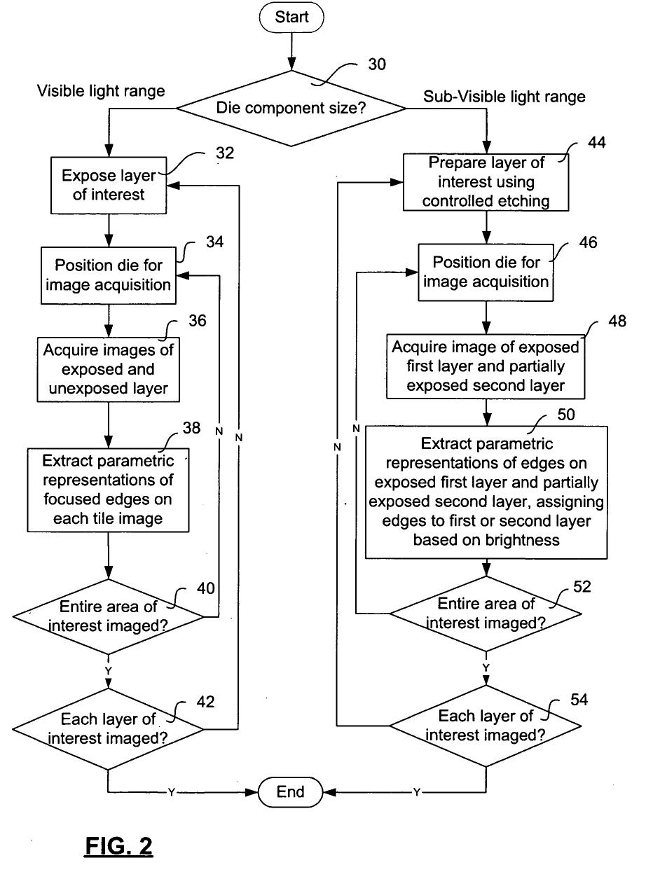

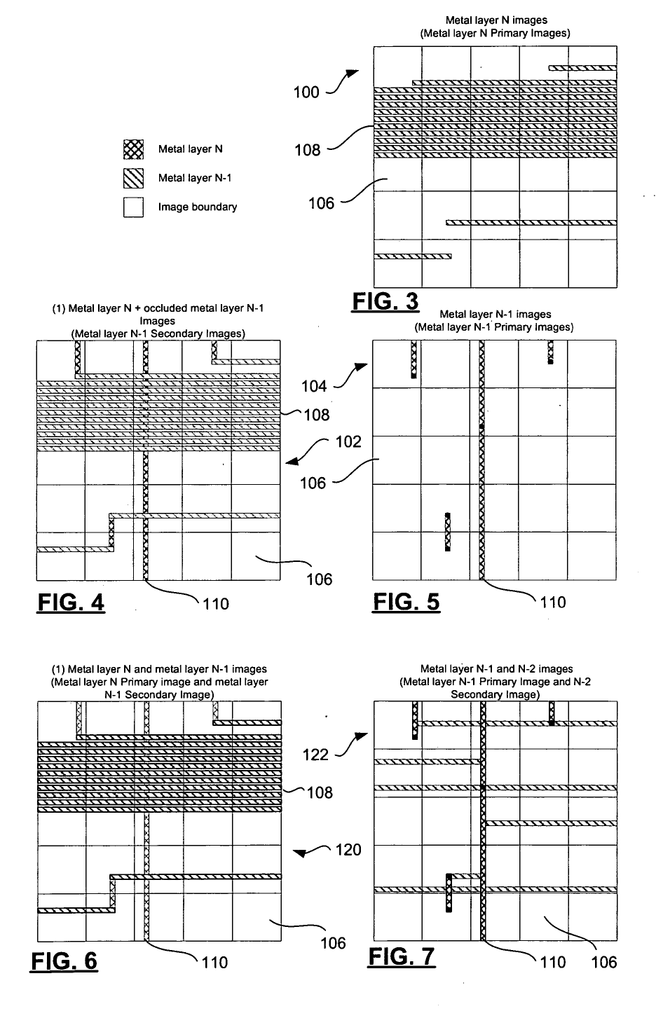

FIG. 2 is a flow chart illustrating a method of image capture in accordance with the invention. As shown in FIG. 2, the integrated circuit die is first inspected to determine a component size (step 30). If the component size is in the visible light range, optical microscopy can be used for imaging the area of interest. In that case, the area of interest is exposed (step 32) using any appropriate technique well know in the art. The die is then positioned on the stage 14 (FIG. 1) to acquire images of the area of interest (step 34). In accordance with the invention, a first image is acquired at a first focus setting to capture a tile image of the exposed metal layer. As is well understood in the art, the insulating layer between layers 1 and 2 is a generally transparent dielectric layer. Consequently, a second image is acquired of the unexposed layer by refocusing the optical microscope without moving the stage. As will be explained below with reference to FIG. 3, the second image shows un-occluded parts of the unexposed layer at the same stage position. Since the stage is not moved between acquisition of the first and second images, an exact vertical alignment between the first and second images exists.

After the first and second images are acquired, parametric representations of focused edges on each image are created by extracting at least one of an X and a Y coordinate of each edge. As will be understood by those skilled in the art, it may not be possible to establish both an X and a Y coordinate for each edge extracted from a tile image. For example, wires that extend across a tile image will provide only one of an X and a Y coordinate. Nonetheless, each edge is extracted as well as one or both X and Y coordinates associated with the edge. The parametric representation also includes an indication of the metal layer with which the edge is associated (step 38). It is then determined in step 40 whether the entire area of interest has been imaged. If not, the process returns to step 34. If so, it is determined whether each layer of interest has been imaged (step 42) if not, the process returns to step 32. Otherwise the process ends.

If it was determined in step 30 that the die component size was in the sub-visible light range, a layer of the area of interest is prepared for imaging using a controlled etching process (step 44) to expose all of the layer as well as at least a part of a layer immediately beneath it. Anisotropic etching may be used with satisfactory results. The die is then positioned on the precision stage 14 for image acquisition (step 46) an image of the exposed first metal layer and partially exposed second metal layer of the die is then captured using, for example, a scanning electron microscope (step 48) which has a depth of field adequate to simultaneously image the exposed first metal layer as well the at least partially exposed second metal layer. Thereafter, parametric representations of edges on the exposed first metal layer and partially exposed second metal layer are extracted (step 50). The extracted edges are assigned to parametric representations on the first metal layer or the second metal layer based on brightness of the respective images. This is achieved because, as will be explained with reference to FIG. 6, although the scanning electron microscope has a depth of field adequate to capture an image of both the exposed first metal layer and partially exposed second metal layer, the exposed first metal layer is brighter in the image than the partially exposed lower layer.

In step 52 it is determined whether the entire area of interest has been imaged. If not, the die is repositioned by relocating the stage (step 46) in a manner well known in the art and steps 48 and 50 are repeated. If the entire area of interest has been imaged, it is determined in step 54 whether each layer of interest has been imaged. If not, the process returns to step 44 and the layer of interest is prepared for imaging. As well be understood by those skilled in art, after the first and second layers are imaged, the first layer is removed from the die sample using buffing or polishing in a manner well known in the art. As will be further understood, as an alternative, a separate die may be used to prepare each of the respective layers for imaging.

FIGS. 3-5 schematically illustrate the image acquisition process when integrated circuits having components of a size that permits image acquisition using optical microscopy in accordance with steps 34-42 shown in FIG. 2. FIG. 3 schematically illustrates tile images of metal layer N. These are images focused to show only the integrated circuit components on metal layer N, in this case tile images 106 show a plurality of metal lines 108 which have been mosaiced to provide a mosaic image 100 in a manner well known in the art. The tile images 106 are primary images (focused images showing only one metal layer) of metal layer N.

FIG. 4 schematically illustrates tile images acquired using optical microscopy in which tile images 106 are acquired by focusing on a metal layer M_{(N-1)} immediately under the metal layer shown in FIG. 3. As is well understood by those skilled in the art, metal layers of integrated circuits are separated by a silicon glass layer which is transparent to visible light. However, because of the magnifications required only one layer can be brought into focus during any given image acquisition process. In accordance with the invention, secondary images (showing a partially obstructed layer in focus) of metal layer M_{(N-1)} are acquired, which are schematically illustrated in FIG. 4. Each tile image 106 in the image mosaic 102 is acquired by changing a focus setting on the optical microscope after acquiring a tile image 106 of the image mosaic 100, without moving the stage. Consequently, the components in metal layer M_{(N-1)} are at least partially occluded by overlying metal layer M_{(N)}.

As shown in FIG. 5, primary tile images 106 of an image mosaic 104 show only metal layer M_{(N-1)}. The primary tile images shown in FIG. 5 were acquired after metal layer M(N) was mechanically or chemically removed using any one a plurality of processes known in the art. As shown in FIG. 5, the wires 110 of metal layer M_{(N-1)} are completely exposed and in focus in the primary image mosaic 104.

FIGS. 6 and 7 illustrate the images acquired for integrated circuits having components of a size in the sub-visible light range. Integrated circuits of this type require imaging equipment such as a scanning electron microscope. As is well understood by those skilled in the, a scanning electron microscope has a greater depth of field than an optical microscope. Consequently, an image of two exposed layers can be captured simultaneously although depending on the choice of imaging parameters of the scanning electron microscope, one layer will have brighter edges than the other layer.

In the image mosaic 120 shown in FIG. 6, tile images 106 capture images of exposed wires 108 in metal layer M_{(N)} and wires 110 in partially exposed metal layer M_{(N-1)}. In order, to accomplish this, as explained above, the integrated circuit is etched in a controlled process to exposed metal layer M_{(N)} and to at least partially expose metal layer M_{(N-1)}. As is understood by those skilled in the art, the dielectric layer separating the two metal layers is opaque to a scanning electron microscope. FIG. 6 therefore schematically represents the primary images of M_{(N)} and the secondary images of metal layer M_{(N-1)}.

FIG.7 schematically illustrates an image mosaic 122 of the primary tile images of the metal layer M_{(N-1)} and the secondary tile images of the metal layer M_{(N-2)}. As will be understood by those skilled in the art, it may be desirable to obtain images of each metal layer alone as the only exposed layer in order to facilitate visual analysis to the mosaiced images. This may be accomplished in the same way practiced in the prior art. Alignment of those mosaiced tile image may be accurately performed using the primary and secondary images shown in FIG. 7, as will be explained below in detailed.

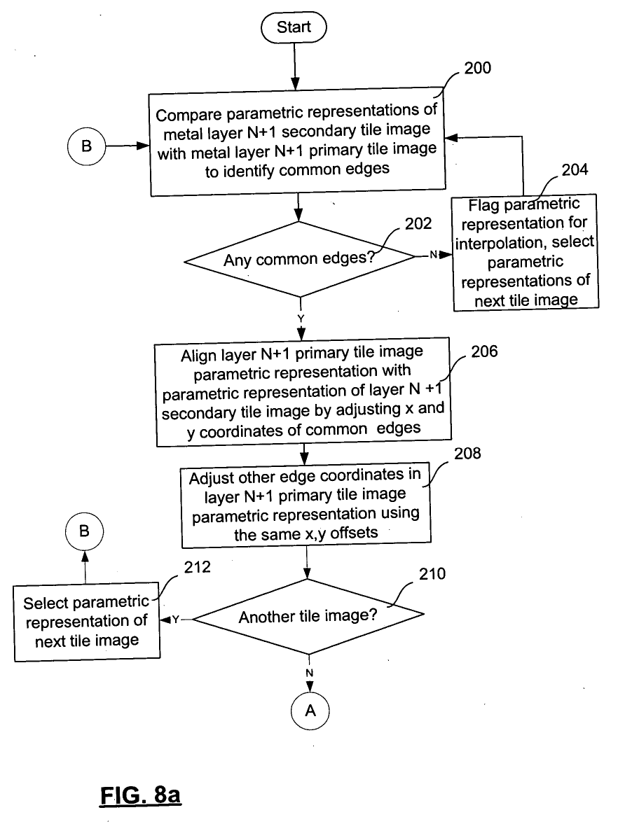

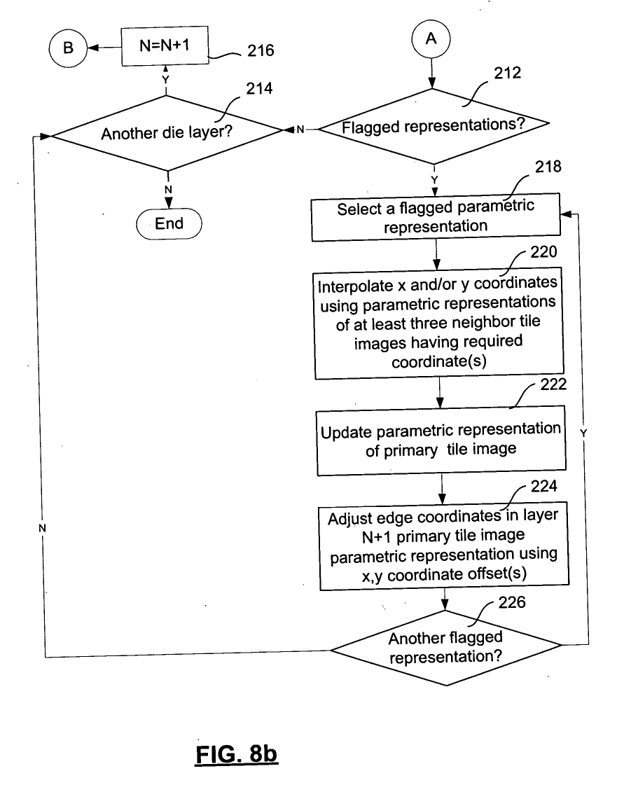

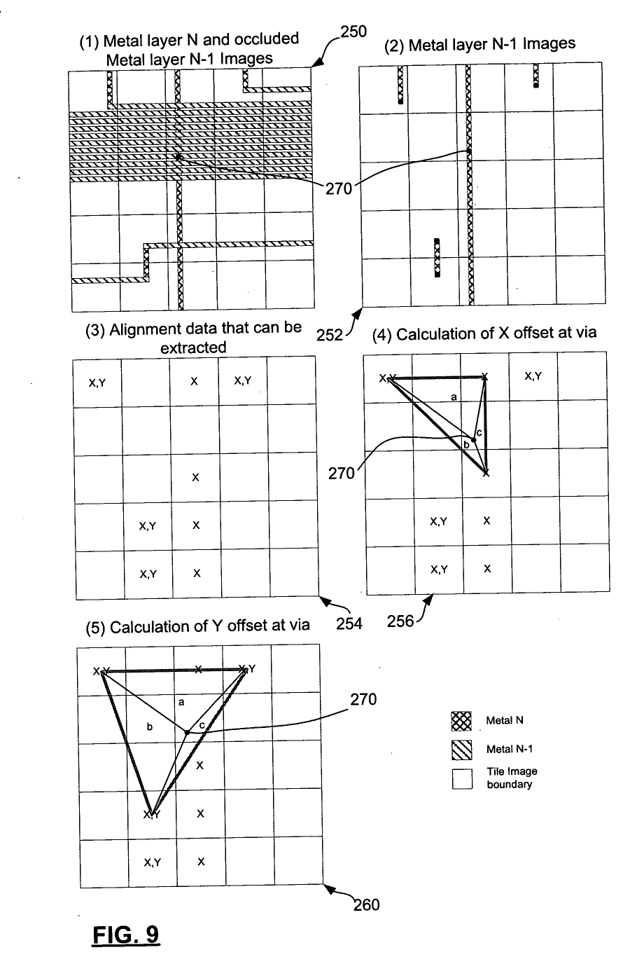

FIGS. 8a and 8b are flow chart of an algorithm in accordance with the invention for adjusting parametric representations of the tile images shown in FIGS. 3-7 to achieve virtual alignment between the images. As is understood by those skilled in the art, the bottom layer of an integrated circuit is normally a polycrystalline silicon layer on which the integrated circuit components are constructed. Layers above are metal interconnect layers containing wires and/or buses for interconnected the first layer components. Consequently, when constructing tile image mosaic for the purpose of analyzing an area of interest the bottom most layer is normally designated layer one and is selected as a die coordinates space home, i.e. a coordinate space used to orient each of the metal layers above. Consequently, the algorithm described in FIGS. 8a and 8b assume that the polycrystalline silicon layer is metal layer N and that image mosaic alignment is accomplished in an order opposite that to which the images are normally acquired.

As shown in FIG. 8a, the algorithm begins by comparing parametric representations of a metal layer N+1 secondary tile image with the parametric representations of the metal layer N+1 primary tile images to identify common edges (step 200). If no common edges are identified (step 202) the parametric representations for metal layer N+1 are flagged for interpolation and parametric representations of a next tile image in the image mosaic is selected (step 204). The process then returns to step 200. If it is determined in step 202 that common edges exist, the layer N+1 primary tile image representation is aligned with the parametric representation of layer N+1 secondary tile image parametric representation, which is known to be in perfect alignment with the corresponding layer N tile image, as explained above. The alignment between the N+1 primary tile image and the N+1 secondary tile image is accomplished by adjusting X and Y coordinates of common edges in the two parametric representations (step 206) so that the N+1 primary tile images vertically align with the N+1 secondary tile images. The other edge coordinates in layer N+1 primary tile image parametric representation are then adjusted using the same X, Y offsets (step 208). It is then determined in step 210 whether another tile image exists in the image mosaic. If so, the parametric representations of the primary and secondary tile image are selected (step 212) and the process returns to step 200.

As shown in FIG. 8b, if no further tile images remain in the image mosaic of layer N+1, it is determined in the step 212 whether parametric representations flagged for interpolation exists. If not, it is determined in step 214 whether tile images of another layer of the same die integrated circuit exists. If not, the process ends. If so, N is incremented by 1 (step 216) and the process returns to step 200 to process the next tile image mosaic of the sample die.

If it is determined in step 212 that parametric representations flagged for interpolation exists, a first of those flagged parametric -representations is selected (step 218). Unknown X and/or Y coordinates are interpolated using parametric representations of at least three neighboring tile images having the required coordinate(s) (step 220). Parametric representations of the flagged primary tile image are then updated (step 222) using interpolated data derived in step 220, as will be explained below in more detail with reference to FIG. 9. The edge coordinates in layer N+1 primary tile image parametric representation are then adjusted (step 224) using the X,Y coordinate offset(s) computed in step 220. In step 226 it is determined whether another flagged parametric representation exists. If not, the process branches back to step 214. If another flagged parametric representation exists, the process branches back to step 218.

FIG. 9 is a schematic diagram of an exemplary process of updating a flagged parametric representation of a tile image in which there are no common edges in both of a primary and secondary tile image of an area of interest of the integrated circuit die. As will be understood by those skilled in the art, this situation can arise when, for example, a primary tile image of an area of interest includes only one or more features that are occluded by overlying upper layer structures in the corresponding secondary tile image.

As shown in FIG. 9 (1) a secondary image of metal layer N and occluded metal layer N−1 includes a via visible in FIG. 9 (2). The via is shown in FIG. 9 (1) for the purpose of illustration at 270, but is occluded by the parallel wires of metal layer N in the actual image mosaic 250 whereas it is visible in the primary mosaic image 252 shown in FIG. 9 (2). FIG. 9 (3) schematically illustrates parametric representation alignment data that can be extracted from the parametric representations of the primary image of metal layer N−1 shown in FIG. 9 (2). As is understood by persons skilled in the art there are many known methods for finding the coordinates of a point when at least one coordinate of some neighboring points are known. By way of example, one method of doing so is to use the well known technique referred to a Delaunay triangulation.

FIG. 9 (4) shows the calculation of the X offset of via 270 which is performed using Delaunay triangulation to interpolate a value located between three known points. If three known X coordinates exist, e.g. locations in the image mosaic where known X offsets are located, the position of the via 270 splits the triangle between the known points into three smaller triangles a, b, c. An area of each triangle a, b and c is then computed. A ratio between the area of each of these triangles and the area of the original triangle gives a weight to an opposite side of the triangle, as will be understood by those skilled in the art of Delaunay triangulation. As will be further understood by those skilled in the art, the algorithm for using Delaunay triangulation can be optimized. The same process is repeated at FIG. 9 (5) to compute Y offset data for the via 270 appearing in the metal layer N−1 primary images.

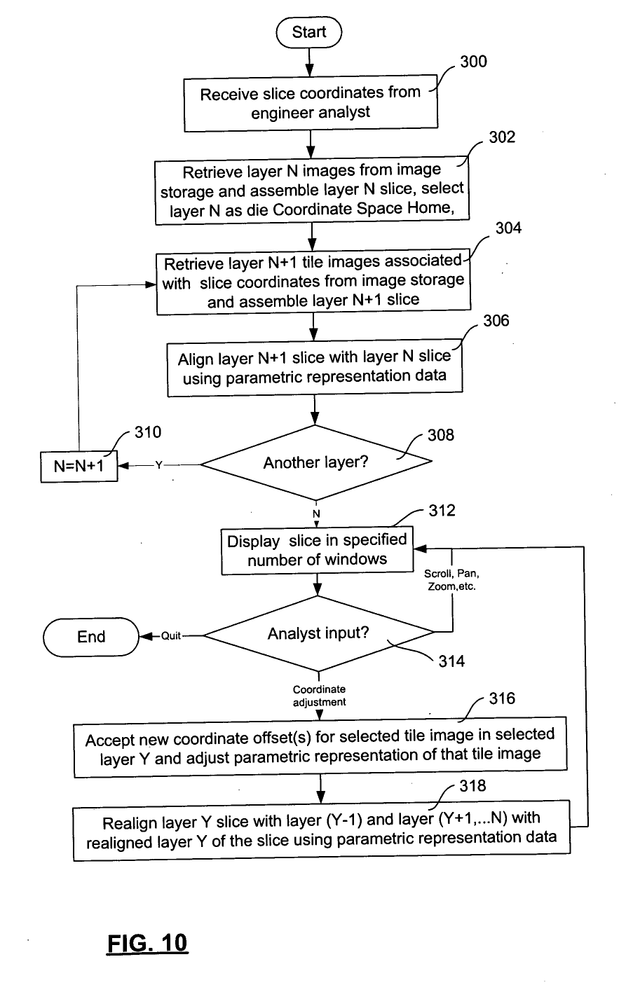

FIG. 10 is a flow chart of a process in accordance with the invention for displaying the tile images representing a slice of an area of interest of an integrated circuit die. As will be understood by those skilled in the art, a “slice” of an area of interest is an area designated by an engineer analysts analyzing the area of interest using a design analysis workstation as described in Applicant's U.S. Pat. No. 6,684,379 which issued on Jan. 27, 2004, the specification of which is incorporated herein by reference.

As shown in FIG. 10, when the design analysis workstation receives slice coordinates from the engineer analyst (step 300) who uses, for example, a mouse connected to the design analysis workstation (not shown) the system retrieves layer N images required to construct the slice from image storage and assembles the layer N slice. The system then designates layer N as the die coordinate space home to provide a die coordinate space with respect to which all other of the layers in the slice are aligned. As will be understood by those skilled in the art, the actual alignment of mosaic images is performed “on-the-fly” by the design analysis workstation. This is done to permit the engineer analysts to add or change alignment offsets if they find areas where the algorithm has fallen short but where their experience or judgment let them determine a correct alignment between tile images that are incorrectly displayed. The output of the image capture process, as explained above is a set of image mosaics with alignment offsets between them, rather than a set of image mosaics that are perfectly aligned, as understood by those skilled in the art. The engineer analysts can use the primary and secondary images as well as his experience to correct alignment errors that may have been made by the algorithm described above with reference to FIGS. 8a and 8b.

In step 304, the system retrieves layer N+1 tile images associated with slice coordinates from imaging storage and assembles the layer N+1 slice. The layer N+1 slice is then aligned with layer N slice coordinates space home using the parametric representation data computed as described with reference to FIGS. 8a and 8b (step 306). In step 308 it is determined whether another layer of the integrated circuit die exists. If so, N is incremented by 1 (step 310) and the process to returns to step 304). If not, the slice is displayed in a specified number of windows on a display surface of the design analysis workstation (step 312).

It is determined in step 314 whether the engineer analyst has inputs. Three engineer analyst's inputs are illustrated for the sake of example only. This list is not intended to be exhaustive. If the engineer analyst inputs a quit command, the process ends. If the engineer analyst inputs a scroll, pan or zoom command, etc., the process returns to step 321. If however, the engineer analysts inputs a new coordinate adjustment for any tile image in any of the slice layer mosaics, the system accepts the new coordinate offsets for the selected tile image in the selected layer Y and adjusts the parametric representations of that tile image. The system then realigns layer Y slice mosaic with layer Y−1 slice mosaic (step 318) thereafter, each of layers Y+1, . . . N is realigned with layer Y of the slice using the parametric representation data resulting from the analysts input.

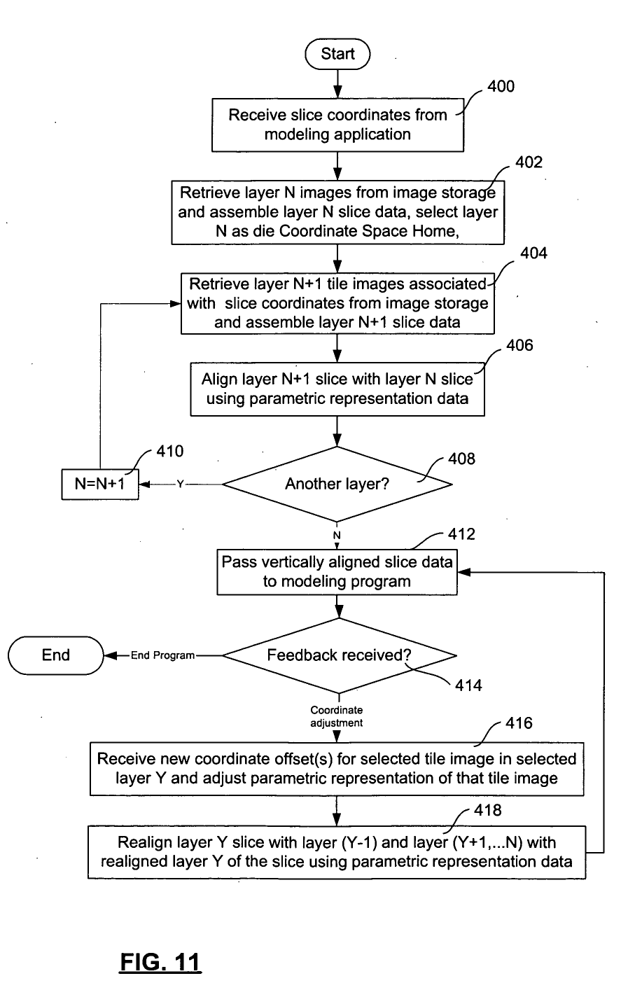

FIG. 11 is a flow chart of a process in accordance with a further aspect of the invention for computing a three-dimensional model of an area of interest of an integrated circuit die. The algorithm begins in step 400 by receiving slice coordinates from a modeling program. The slice coordinates would normally be coordinates of the entire area of interest, though any selected portion of the area of interest may be modeled, as desired. On receiving the slice coordinates, the algorithm retrieves layer N images from image storage and assembles parametric data associated with the layer N slices. The system then designates layer N as die coordinates space home. Optionally, the algorithm may analyze layer N tile images to build a netlist using pattern matching in a manner known in the art. The system then retrieves layer N+1 tile images associated with the slice coordinates from image storage and assembles layer N+1 slice data (step 404). The system then aligns layer N+1 slice data with layer N slice data using the parametric representation data (step 406). In step 408 it is determined whether there is another layer of images in image storage (step 408). If so, N is incremented by 1 (step 410) and the process returns to step 404. If not, the vertically aligned slice data is passed to the modeling program (step 412) and the modeling program executes to construct a three-dimensional model of the slice in a manner known in the art. The algorithm then waits for feedback from the modeling program. The feedback may constitute an end program command, in which case the algorithm terminates. The modeling program may also detect an inconsistency in the data and provide a coordinate adjustment to the algorithm indicating an error in the alignment of images. If the algorithm receives a coordinate adjustment from the modeling program, it adjusts the parametric representation of the selected tile image in the layer Y (step 416). The algorithm then realigns the layer Y slice with the layer Y−1 slice (step 418) and then aligns layer Y+1, . . . N with realigned layer Y of the slice using the parametric representation data. Thereafter the algorithm returns to step 412 and passes the vertically re-aligned slice data to the modeling program.

The embodiment(s) of the invention described above is(are) intended to be exemplary only. The scope of the invention is therefore intended to be limited solely by the scope of the appended claims.

I/WE CLAIM:

1. A system for vertically aligning tile images of an area of interest of an integrated circuit having N metal layers M, where N>1, comprising a parametric representation algorithm for extracting parametric representations of edges from a tile image showing metal layer (M_{N}) and at least a part of metal layer (M_{N-1}) of the integrated circuit to produce a parametric representation of the edges visible on the respective metal layers, the parametric representation including an indication of the metal layer with which each extracted edge is associated and at least one of x and y coordinates associated with each of the extracted edges.

2. The system as claimed in claim 1 further comprising an alignment algorithm for comparing the parametric representation of a tile image associated with metal layer (M_{N}) and a corresponding tile image associated with a metal layer (M_{N+1}), to establish vertical alignment between the tile image of metal layer metal layer (M_{N}) and the tile image of the metal layer (M_{N+1}) using the coordinates of the common edges identified in both a primary and a secondary tile image associated with the metal layer (M_{N+1}).

3. The system as claimed in claim 1 further comprising an image capture system comprising optical microscopy wherein the tile image comprises an image taken from metal layer (M_{N}) at a focus setting for imaging features of the exposed part of metal layer (M_{N-1}).

4. The system as claimed in claim 1 further comprising an anisotropic etching machine for preparing the respective metal layers for imaging, the etching machine being controllable to expose metal layer (M_{N}) and at least a part of a top surface of metal layer (M_{N-1}).

5. The system as claimed in claim 4 further comprising an image capture system that comprises a scanning electron microscope, wherein the tile image comprises an image taken from metal layer(M_{N}), the scanning electron microscope imaging both metal layer (M_{N}) and the exposed part of the top surface of metal layer (M_{N-1}).

6. The system as claimed in claim 1 further comprising a design analysis workstation for displaying a slice of an area of interest of the integrated circuit, the design analysis workstation comprising an interface for accepting input from an engineer analyst.

7. The system as claimed in claim 6 wherein the interface is adapted to accept edge position adjustment coordinates from the engineer analyst.

8. The system as claimed in claim 7 wherein the system uses the edge position adjustment coordinates to realign tile images associated with the area of interest based on the edge position adjustment coordinates input by the engineer analyst.

9. A method of vertically aligning tile images of an area of interest of an integrated circuit having N metal layers M, where N is an integer and N>1, comprising:
preparing a surface of the integrated circuit to permit an area of interest of the metal layer (M_{N}) and at least a part of a top surface of the metal layer (M_{N-1}) to be imaged;
capturing at least one tile image of the area of interest of the metal layer (M_{N}) and the top surface of the metal layer (M_{N-1}) of the integrated circuit;
extracting edges of a secondary tile image of the top surface of metal layer (M_{N-1}) and a primary tile image of the same area of metal layer (M_{N-1}); and
creating a parametric representation of edges visible in the tile images of the respective metal layers, the parametric representations including an indication of the metal layer with which each extracted edge is associated.

10. The method as claimed in claim 9 wherein the components of the integrated circuit are of a size that permits them to be imaged using visible light, an the preparing comprises exposing a one of the metal layers of the integrated circuit.

11. The method as claimed in claim 10 wherein the capturing comprises:
positioning a stage of an optical imaging system to capture a tile image of the area of interest;
capturing a first image of the area of interest that is focused on the exposed metal layer; and
changing the focus of the optical imaging system to focus on an unexposed metal layer immediately under the exposed metal layer, and capturing a tile image of the unexposed metal layer without repositioning the stage.

12. The method as claimed in claim 9 wherein the components of the integrated circuit are of a size that does not permit them to be imaged using visible light, and the preparing comprises etching the integrated circuit to expose a first of the metal layers and at least a part of a top surface of a second of the metal layers immediately under the exposed first metal layer.

13. The method as claimed in claim 12 wherein the capturing comprises:
positioning a stage of an imaging system in a position to capture a tile image of an area of interest of the integrated circuit; and
capturing an image of the area of interest using a scanning electron microscope that has a depth of field adequate to capture an image of both the first metal layer and the exposed part of the second metal layer.

14. The method as claimed in claim 9 wherein extracting the metal edges comprises determining at least one of an x and a y coordinate of each metal edge visible in the tile image.

15. The method as claimed in claim 9 further comprising comparing parametric representations of layer (M_{N}) and layer (M_{N+1}) to identify common edges, and flagging the parametric representation of the tile image for interpolation in an instance when no common edges are located.

16. The method as claimed in claim 15 further comprising aligning the parametric representations of metal layer (M_{N+1}) with that of layer (M_{N}) by adjusting at least one of the x and the y coordinates of the common edges in the parametric representation of metal layer (M_{N+1}) to accord with those in the metal layer (M_{N}).

17. The method as claimed in claim 16 further comprising adjusting at least one of the x and the y coordinates of all other edges in the parametric representation of metal layer (M_{N+1}) using a same x and y offset.

18. The method as claimed in claim 17 further comprising:
selecting flagged parametric representations of tile images;
interpolating at least one of an x and a y coordinate of each edge identified in the parametric representation using parametric representations of at least three neighboring tile images having a required one of the x and the y coordinates;
updating the flagged parametric representation of the tile image;
creating or updating a parametric representation of a primary image associated with the flagged parametric representation of the tile image by determining or adjusting edge coordinates of edges represented in the parametric representation of the primary image using x and y offsets computed using interpolated ones of the x and y coordinates.

19. The method as claimed in claim 18 further comprising:
receiving slice coordinates from an engineer analyst for displaying a slice of the area of interest;
retrieving layer (M_{N}) images associated with the slice from image storage and assembling the layer (M_{N}) slice;
selecting a die coordinate space of layer (M_{N}) of the integrated circuit as a die coordinate space home;
retrieving layer (M_{N+1}) images associated with the slice from image storage and assembling the layer (M_{N+1}) slice;
aligning respective tile images of the layer (M_{N+1}) slice with corresponding tile images of the layer (M_{N-1}) slice using parametric representation data associated with the respective tile images; and
incrementing N by one and repeating the steps of retrieving and aligning for each layer in the slice.

20. The method as claimed in claim 19 further comprising:
accepting engineer analyst input specifying coordinate adjustments for a selected tile image associated with a layer of the slice;
adjusting the parametric representation of selected tile image based on the input;
realigning the selected layer with an adjacent layer closer to the die coordinate space home; and
realigning the selected layer with each other layer farther from the die coordinate space home using the parametric representations of respective tile images associated with the respective layers.

21. The method as claimed in claim 9 further comprising:
receiving slice coordinates from a modeling program, the slice coordinates designating a selected portion of the area of interest to be modeled;
retrieving layer N images from image storage and assembling parametric data associated with the layer N slice;
designating layer N as die coordinates space home;
analyzing layer N tile images to build a netlist using pattern matching;
retrieving layer N+1 tile images associated with the slice coordinates from image storage and
assembling layer N+1 slice data;
aligning layer N+1 slice data with layer N slice data using the parametric representations;
determining whether there is another layer of images in image storage, and if so, incrementing N by 1 and repeating the retrieving and aligning until all layers in the slice are aligned; and
passing vertically aligned slice data to the modeling application which constructs a three-dimensional model of-the slice.
